(19) United States
(12) Patent Application Publication
(10) Pub. No.: US 2018/0250850 A1
(43) Pub. Date: Sep. 6, 2018

(54) COMPOSITE MATERIAL FOR 3D PRINTING PRODUCED BY PULTRUSION METHOD

(71) Applicant: APIS COR ENGINEERING, LLC, Owings Mills, MD (US)

(72) Inventor: Nikita CHEN-IUN-TAI, Irkutsk (RU)

(21) Appl. No.: 15/972,507

(22) Filed: May 7, 2018

Related U.S. Application Data
(63) Continuation-in-part of application No. 15/811,837, filed on Nov. 14, 2017.
Application No. 15/811,837 is a continuation-in-part of application No. 15/170,235, filed on Jun. 1, 2016.
(60) Provisional application No. 62/502,963, filed on May 8, 2017.

(51) Int. Cl. B29B 15/14; B33Y 10/00; B33Y 30/00; B33Y 70/00; B29C 64/118; B29C 64/209; E04B 1/16; E04B 1/35; E04C 5/07; E04G 21/04

(52) U.S. Cl. CPC B29B 15/14; B33Y 10/00; B33Y 30/00; B33Y 70/00; B29C 64/118; B29K 2055/02; E04B 1/16; E04B 1/3505; E04C 5/07; E04G 21/0463; B29C 64/209

(57) ABSTRACT

A composite material and method for making the same is disclosed. Also disclosed are methods for printing the composite material and devices which are used for printing the composite material. The composite material comprises roving which is impregnated with thermoplastic material via a modified pultrusion method. The composite material is then used in 3D printing of buildings either in combination with concrete printing or alone. The composite material may be extruded in solid form or in a soft form, depending on the extruding mechanism employed by a given 3D printer. The material is printed by 3D printers employing polar coordinate system software and hardware.

### CROSS-REFERENCE TO RELATED APPLICATIONS

This patent application claims priority to U.S. Provisional Patent Application Ser. No. 62/502,963 filed on May 8, 2017, it is also a Continuation-in-part of co-pending U.S. patent application Ser. No. 15/811,837 and co-pending U.S. patent application Ser. No. 15/170,235, all of which are incorporated fully herein by reference.

### FIELD OF THE INVENTION

The present invention relates to a process of making and using thermoplastic composite material having roving reinforcement, and more particularly, to the making and use of a consolidated form of commingled continuous filaments of roving as interspersed, continuous, or bulk reinforcement in 3D building products.

### BACKGROUND OF THE INVENTION

Long fiber-reinforced thermoplastic composites are well known. There is disclosed, for example, in U.S. Pat. No. 5,830,304 to Priesnitz et al. a method of making a core element for a communications cable. The method described in the '304 patent includes assembling mixed filaments containing glass fibers and thermoplastic fibers, heating the bundle of mixed filaments to melt the thermoplastic fibers to form a matrix with the glass fibers embedded therein, then extruding an outer covering of the desired outside diameter for the core element onto the bundle. If desired, the melted bundle can be passed through a shaping device, which is preferably heated prior to extruding the coating thereon.

Pultrusion processes are also well known. In U.S. Pat. No. RE 32,772 to Hawley, there is disclosed a method of making a composite pultruded structure by injection molding thermoplastic resin onto continuous glass fibers in a lobed pultrusion die. Further, U.S. Pat. No. 6,090,319 to Sharma et al. discloses a process including pultrusion followed by coating. The process is characterized by impregnating a plurality of continuous lengths of reinforcing fiber strands with a first thermoplastic resin material while continuously drawing the fiber strands to produce a long fiber-reinforcing composite structure followed by coating a second thermoplastic resin material containing additives onto the long fiber-reinforcing composite structure to produce a coated, long fiber-reinforcing composite structure. The coating additives may be selected from mineral reinforcing agents, lubricants, flame retardants, blowing agents, foaming agents, ultraviolet light resistant agents, heat sensitive pigments and so forth.

There are also numerous publications relating to composites. As to methods and apparatuses for producing composite strands, see U.S. Pat. Nos. 5,454,846; 5,316,561; and 5,001,523. As to processes used in preparing fibrous tows which may be formed into polymeric plastic composites and a continuous tow useful in forming composite molded articles see, U.S. Pat. Nos. 4,818,318; 4,799,985; 5,355,567; 4,871,491; and 4,874,563. As to a process for preparing fiber-reinforced thermoplastic articles see, U.S. Pat. Nos. 4,800,113 and 4,925,729. As to reinforced pultrusion products, see U.S. Pat. No. 6,037,056. As to composite materials comprising a thermoplastic resin and a reinforcing fiber, see U.S. Pat. Nos. 5,076,872; 4,770,915; and 4,539,249. As to hybrid yams containing reinforcing and thermoplastic fibers, see U.S. Pat. Nos. 5,227,236 and 5,910,361. For a molding material for thermoplastic composites see, U.S. Pat. No. 5,959,710.

Still yet, other related processes are described in U.S. Pat. Nos. 5,626,643 and 5,451,355 as well as WO 01/81073A which describe fiber-reinforced, heat-formable material which contains thermoplastic fibers and reinforcing fibers aligned in parallel. U.S. Pat. No. 5,626,643 is related to assembling the different fibers directly at a glass bushing. In patent application WO 01/81073 A, the following consolidating steps are necessary, after assembling a minimum of two sources of fibers: heating (oven), forming rolls/impregnation system, shaping and coating. See, also, WO 98/16359.

Despite all current advances in the art, there exists a need for improvements in production rates, simplification of processing, and especially for long fiber-reinforced thermoplastic composites which are used in 3-D printing machines, including performance resins such as polyesters, polyamides, and the like. The present invention addresses these and other issues.

### SUMMARY OF THE INVENTION

The present invention discloses a composite material, a method for making the composite material, a composite material printer/extruder, and a method for printing the composite material via the composite material printer/extruder.

The composite material disclosed comprises one or more roving materials, the roving material being impregnated with one or more thermosoftening plastic materials (thermoplastics), wherein the composite material is fed into a 3D printing device, the composite material being used as a reinforcing material of a structure produced by the 3D printing device.

The disclosed method for making the composite material comprises (1) heating in a bunker one or more thermoplastic materials to form a thermosoftened material, (2) unwinding a roving material and feeding the unwound roving material into a heated die, (3) feeding the thermosoftened material into the heated die, the thermosoftened material being driven into the die via a screw motor, (4) impregnating the roving material with the thermosoftened material within the heated die, (5) pulling the impregnated roving material through a shape-forming nozzle by a synchronized pulling machine, wherein the impregnated roving material solidifies once it's removed from the heated die to form a thread of composite material, the thread of composite material having a constant cross section, and (6) winding the thread of composite material about a spool for storage purposes.

The disclosed composite material printer/extruder comprises a housing, an opening within the housing for receiving a composite material thread in a hardened form, a feeding gear within the housing, a pressing roller within the housing which is positioned adjacent to the feeding gear such that the composite material thread in a hardened form is pulled further into the housing between the feeding gear and the pressing roller, and an outlet through which the composite material thread continues to run. The outlet itself comprises a thermoisolator section, a heater section for heating the composite material thread into a thermosoftened form, and an extruder head for extruding the thermosoftened form of the composite material thread.

The disclosed method for printing the composite material comprises (1) providing a thread of composite material, the composite material comprising one or more roving materials, wherein the roving material is impregnated with one or more thermosoftening plastic materials, and (2) feeding the composite material thread into a 3D printer, wherein the 3D printer extrudes the composite material thread based on a polar coordinate 3D printing program.

### BRIEF DESCRIPTION OF THE DRAWINGS

FIG. 1 shows an exemplary operation of the 3D printer in the X and Y planes.

FIG. 2 shows an exemplary operation of the 3D printer in the X and Z planes.

FIG. 3 shows an alternative embodiment of the operation of the 3D printer in the X and Z planes.

FIG. 4 shows the 3D printer system as a whole.

FIG. 5 shows additional details of the rotation mechanism.

FIG. 6 shows a flow chart of an exemplary method of operating the 3D printer.

FIG. 7 shows a diagram for an exemplary method of making composite material according to the present invention.

FIG. 8 shows an exemplary 3D printer head comprising an extruder for concrete with a spool of composite material coupled to the 3D printer head.

FIG. 9 shows an exemplary embodiment of a composite material extruder according to the present invention.

FIG. 10 shows a flow chart of an exemplary method for making composite material according to the present invention.

### DETAILED DESCRIPTION OF THE PREFERRED EMBODIMENT

The composite material of the present invention comprises at least two parts. The first part is roving. The roving may comprise glass roving, carbon roving, Kevlar roving, basalt roving, and any other known types of roving. The roving acts as a reinforcing material. The second part of the composite material is one or more thermoplastic materials, such as but not limited to, ABS (acrylonitrile butadiene styrene) plastics, PLA (polylactic acid) plastics, nylon, HDPE (high density polyethylene), and any other known thermoplastics. The thermoplastic materials act as a binder for the roving. It is noted that various types of roving may be combined into one composite material thread produced by the method of the present invention. For example, glass roving may be combined with any other type of roving, bound by one or more thermoplastic materials. The composition of various rovings within a given composite material thread depends on the desired strength and application of the composite material.

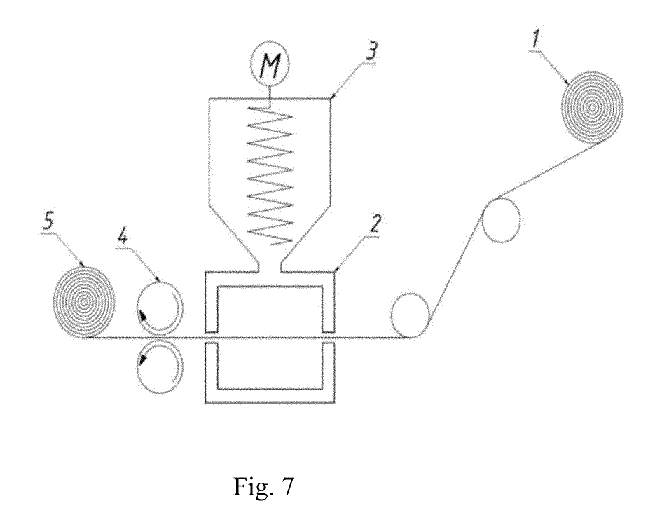

The composite material is produced via a modified pultrusion method (see FIG. 7). In a preferred embodiment, the roving is taken from coils 1 and supplied into a heated die 2 in which melted binder (i.e., thermoplastic materials) is supplied via the pressure of a screw auger extruder with a bunker 3. The roving is soaked in liquid thermoplastic material directly in the heated die. The roving is impregnated with the binder and the material is pulled out from a shape-forming die nozzle by a synchronized pulling machine 4. The temperature associated with the impregnation depends on the thermoplastic material used and can range from 100 to 300 degrees Celsius. The material is then wound about a spool 5. Once the thread of fiber leaves the die, the binder sets hard, which results in a constant-section product. The product comprises a composite thread having a consistent circular cross-section, which can be of differing diameters (e.g., 0.5 mm to 10 mm in diameter).

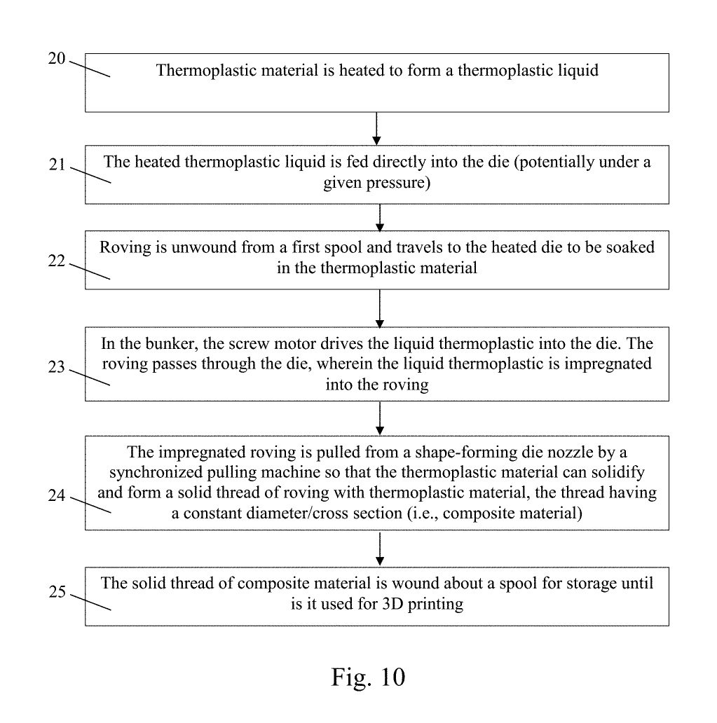

The present invention introduces thermoplastic material as a new binder for roving to produce the composite material discussed herein. The present invention also discloses a method for producing this composite material. In order to impregnate a roving with thermoplastic material, the process for pultrusion must be modified from known methods which use resin as the binder instead. Specifically, the method for impregnating the roving with a thermoplastic to form a composite material comprises the following steps (FIGS. 7 and 10):

(1) Thermoplastic material (e.g., plastic) is heated to form a thermoplastic liquid 20.

(2) The heated thermoplastic liquid is fed directly into the die (potentially under a given pressure) 21.

(3) Roving is unwound from a first spool and travels to the heated die to be soaked in the thermoplastic material (e.g., plastic) 22.

(4) In the bunker, the screw motor drives the liquid thermoplastic into the die. The roving passes through the die, wherein the liquid thermoplastic is impregnated into the roving 23.

(5) The impregnated roving is pulled from a shape-forming die nozzle by a synchronized pulling machine so that the thermoplastic material can solidify and form a solid thread of roving with thermoplastic material, the thread having a constant diameter/cross section (i.e., composite material) 24.

(6) The solid thread of composite material is wound about a spool for storage until is it used for 3D printing 25.

The composition of the composite material (thread) comprises between 60% and 90% roving, and between 10% and 40% thermoplastic material. The composition depends on the production process, which controls the proportion of roving to binder.

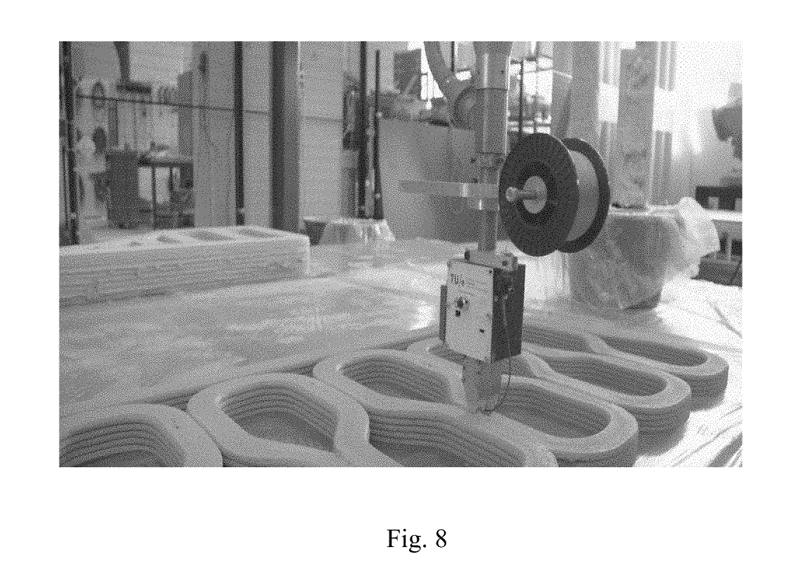

The composite material product is stored by being wound about a spool. The wound spool may then be transferred to a 3D printing machine, wherein the 3D printing machine extrudes the composite material in accordance with a coordinate program for a building. The composite material may be used alone as the main material for printing objects and details, or the composite material may be used in combination with a cement/concrete mixture for printing buildings with a reinforced concrete (i.e., cement reinforced with composite material, see FIG. 8). In the latter case, the 3D printing machine comprises 2 (or more) extruders, the first extruder extruding a concrete mixture, and the second extruder extruding impregnated roving (i.e., composite material of the present invention) which acts as reinforcement of the concrete mixture and is added at specific intervals of the printing process. The composite material is moldable, as described hereinbelow, to form any shape via a special extruder, which is useful when only the composite material is to be printed. The key to creating a moldable composite material is to apply heat to the composite material as it is extruded or just prior to extrusion. Once the heat dissipates, the composite material once again hardens into the shape and position formed by the printer head and/or extruder.

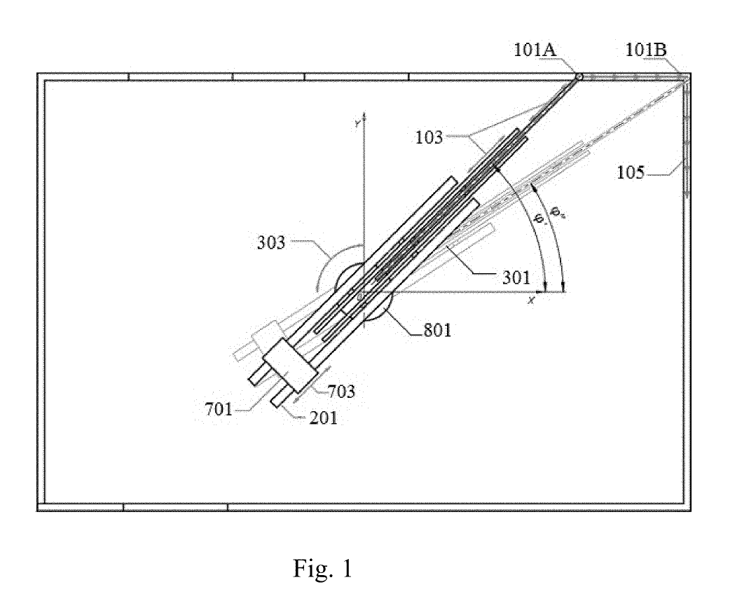

The resulting composite material may be used by any 3D printing machine where extrusion technology is used during layer forming. FIG. 1 shows an embodiment of a 3D printer in operation as in the X and Y plane. The 3D printer is configured to automatically build a structure for which it has been given design schematics for. The 3D printer has a rotation mechanism 801A. Mounted to the rotation mechanism 801A is an extendable boom arm 201 with telescoping extendable sections 301. The extendable boom arm 201 with extendable sections 301 are only capable of translational motion 103 extending and contracting the reach. The extendable sections 301 are not like segments of a robotic arm wherein the section have full independent movement relative to one another. The center of rotation mechanism 801A is located a point 0,0 of an X and Y coordinate system. At the end of the extendable sections 301 there is an extruder 1401 which moves from point 101A to point 101B during deposition of a concrete-based chemical solution or a composite material or both.

The 3D printer is located in the center of the work zone (starting coordinate, 0) and carries out rotational 303 and translational 103 motions in XOY plane, resulting in extruder 1401 moving along points 101A and 101B while completing a specified trajectory 105. Thus, during transformation of the construction from one position to another position, the extruder 1401 travels the path from point 101A to point B, extruder travel is entered in polar coordinate system, wherein projection of extruder 1401 position onto the XOY plane is determined by its distance from the axis of rotation (starting coordinate, 0) with angle of its radius-vector to abscissa ϕ′ to ϕ″.

### Embodiment 1

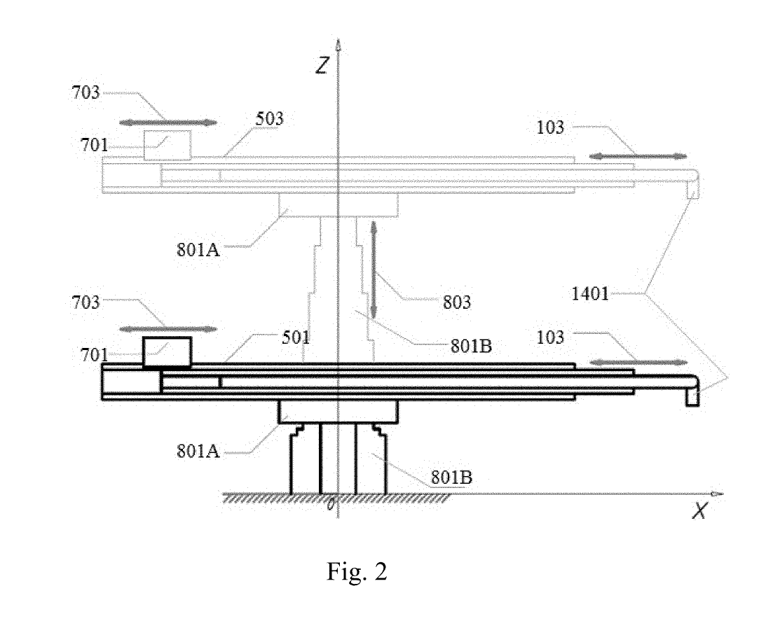

Referring to FIG. 1 and FIG. 2, in addition to the translational 103 and rotational 303 motion in the XOY plane, the device carries out translational motions 803 along the Z axis during the printing process, as a result of which the extruder 1401 can be raised and lowered, taking up positions at 501 or 503, respectively. The height of the extruder 1401 is determined in the XOZ plane by its applicate (its coordinate on the Z axis), or by the distance from it to the XOY plane in space.

In a preferred embodiment, the design allows printing a construction, encompassing the surroundings out to a radius of 20 meters, with center at the point where coordinates start. In alternative embodiments, the radius is greater than 20 meters.

In this embodiment the rotation mechanism 801A is located between extendable boom arm 201 with telescoping extendable sections 301 with extruder 1401 and telescoping-type lift mechanism 801B, so that during printing process only the extendable boom arm and nodes touching it rotate. Telescoping-type lift mechanism 801B does not rotate, it is the base of 3D printer.

The 3D printer does not need its base to be anchored to a support, since it includes a counterweight mechanism 701, which corrects the overall center of mass during extendable boom arm movements 103 such that it coincides with the axis of rotation Z. This correction is performed by the movement of the load of the counterweight mechanism 701 in the specified direction 703.

Rotation mechanism 801A is located at the junction of the extendable boom arm 201 with telescoping extendable sections 301 and printer lift node, the telescoping-type lift mechanism 801B, providing the following in addition to its primary function:

Transmitting the electrical signal from control node to the motors;

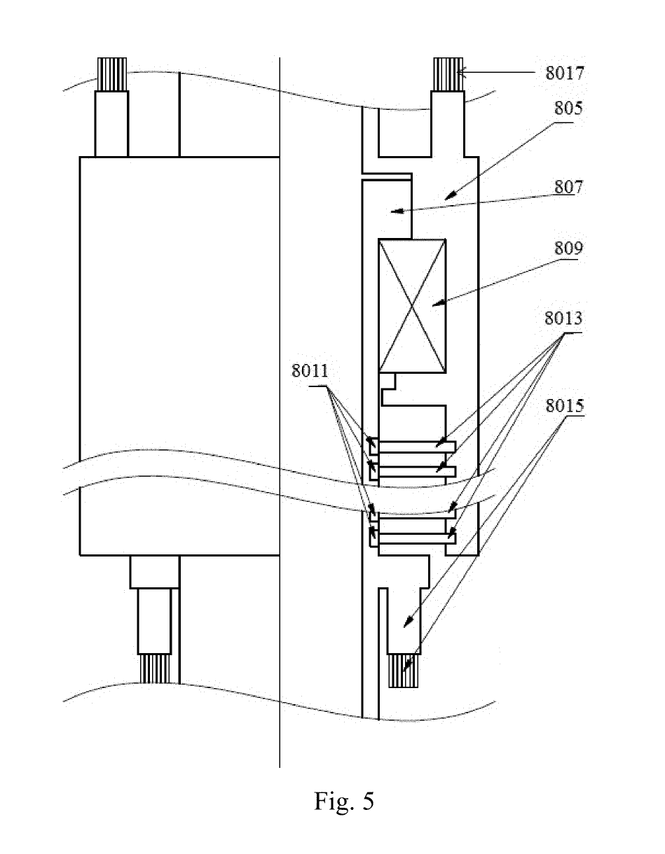

Feeding a dry mixture into a combination concrete mixture and pump 2101 (FIG. 5) to the extruder 1401; and

Transmitting miscellaneous communications from the base to the rotating extendable boom arm 201.

Feeding of the solution is implemented using a rotary connector, and in the connector assembly using sliding contacts—graphite brushes and brass whiskers slide along gold-plated rings, which allows rotation of the turning part in any direction an unlimited number of times.

On the print head—extruder 1401 has a special rotary trowel device (not shown), which provides high quality printing surface, which does not need additional cleaning. In addition to this, the design of the extruder is such that it can change the direction of the nozzle, which allows it to print not only straight, but also curved, spherical sections.

### Embodiment 2

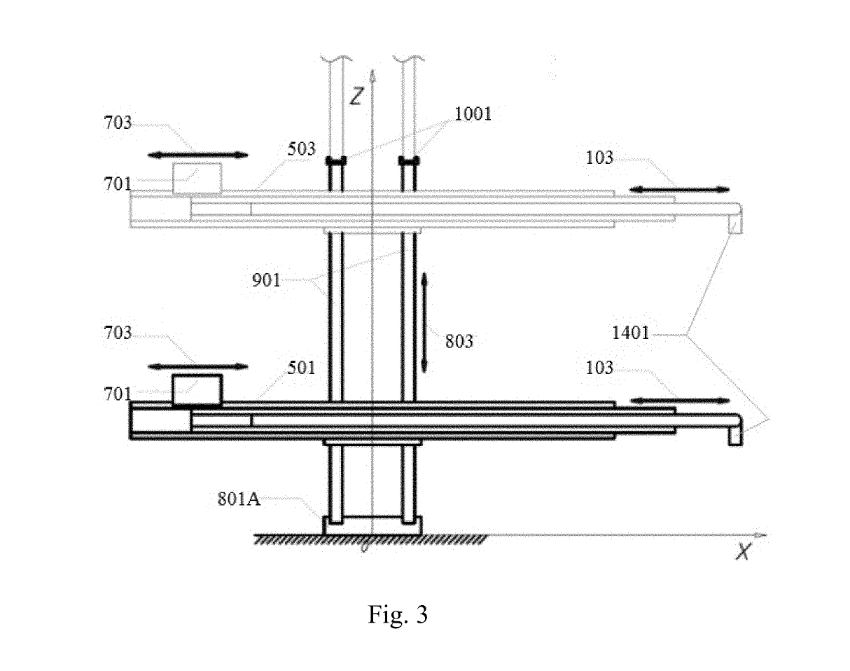

Referring to FIG. 1 and FIG. 3, in addition to the translational 103 and rotational 303 motion in the X and Y plane, the device carries out translational motions 803 along the Z axis during the printing process, as a result of which the extruder 1401 can be raised and lowered, taking up positions at 501 or 503, respectively. The height of the extruder 1401 is determined in the XOZ plane by its applicate (its coordinate on the Z axis), or by the distance from it to the XOY plane in space. In a preferred embodiment the design allows printing a construction, encompassing the surroundings out to a radius of 20 meters, with center at the point where coordinates start. In alternative embodiments the radius is greater than 20 meters.

The rotation mechanism 801A is located in the base of the whole construction, the 3D printer, wherein during the printing process, the extendable boom arm 201 with telescoping extendable sections 301 and all nodes connected to it (counterweight mechanism 701, extruder 1401, etc.) rotate, as does the lift mechanism 901, presented in the form of a truss.

The device does not need its base to be anchored to a support, since it includes a counterweight mechanism 701, which corrects the overall center of mass during extendable boom arm movements 103 such that it coincides with the axis of rotation Z. This correction is performed by the movement of the load of the counterweight mechanism 701 in the specified direction 703.

Rotation mechanism 801A is located in the base of the construction, the 3D printer, providing:

Transmitting the electrical signal from control node to the motors;

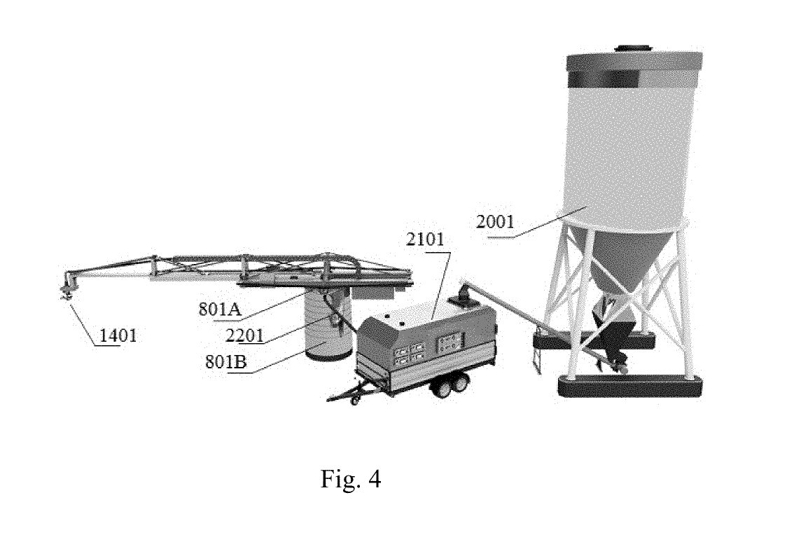

Feeding a dry mixture into a combination concrete mixture and pump 2101 (FIG. 4) to the extruder 1401; and

Transmitting miscellaneous communications from the base to the rotating extendable boom arm 201.

Feeding of the solution is implemented using a rotary connector, and in the connector assembly using sliding contacts—graphite brushes and brass whiskers slide along gold-plated rings, which allows rotation of the turning part in any direction an unlimited number of times.

On the print head—extruder 1401 has a special rotary trowel device (not shown), which provides high quality printing surface, which does not need additional cleaning. In addition to this, the design of the extruder is such that it can change the direction of the nozzle, which allows it to print not only straight, but also curved, spherical sections.

The lift mechanism consists of truss 901, mounted on the rotation mechanism 801A. 503 extendable boom arm 201 with telescoping extendable sections 301 and all nodes touching it (counterweight mechanism 701, extruder 1401, etc.) perform necessary movements 803 along this truss 901. Special mounts 1001 on the end of the truss 901 allow building up of the truss, as a result of which it is possible to print second and subsequent floors of a building, the quantity of which depends on device dimensions.

Referring to FIG. 4, and regarding both embodiments 1 and 2—rotation mechanism 801A is connected to combination concrete mixer and pump 2101 by connection hose or pipe 2201. Combination concrete mixer and pump 2101 contains pump control systems to change the pressure and flow rate of the concrete-based chemical solution. Combination concrete mixer and pump 2101 is connected to dry mixture supply 2001. The dry mixture supply 2001 can be a storage unit (as shown) or could be a transport truck that pours its content into a trough or other feeding unit for combination concrete mixer and pump 2101. Dry concrete-based chemical is stored in the dry mixture supply 2001 which is then brought into the combination concrete mixer and pump 2101 where the dry concrete-based chemical is mixed with a predetermined proportion of water to form the concrete-based chemical solution and then pumped by the combination concrete mixer and pump 2101 through the 3D printer to the extruder 1401.

Concrete-based chemical solution is under an operational pressure of 40 bars into a special hose for abrasive materials (such as concrete) 2201. Supply combination concrete mixer and pump 2101 is either gerotor or piston type. Combination concrete mixer and pump 2101 is synchronized with the 3D printer and provides solution both fast and precise, regulating supply volume from 0 to 120 liters per minute. Extruder 1401 does not move with a constant trajectory speed, it slows down on corners when it changes movement direction to avoid vibrations. Thus, when the extrusion head slows down or speeds up—the concrete-based chemical solution supply volume varies in accordance with a software control.

The extrusion of composite material with concrete is also possible. In one embodiment, coupled to the extruder for concrete is a spool of composite material according to the present invention. The composite material thread is then run through the same extruder and released together with the concrete through the same nozzle. Thus, every portion of extruded concrete also comprises reinforcing material comprising the composite material of the present invention. The release of composite material is synchronized with the supply of concrete. Furthermore, the supply of concrete with composite material is synchronized with the speed of the printer head.

In another embodiment, the printing device comprises two separate extruders—a concrete extruder and a composite material extruder. In some embodiments, the composite material and concrete are extruded simultaneously but through separate extruders. In other embodiments, the concrete extruder may function while the composite material extruder does not function (and vice versa). If soft concrete is not extruded with the composite material, it may be necessary to provide a composite material extruder which is capable of melting the composite material thread itself in order to create a moldable extruded product (without concrete).

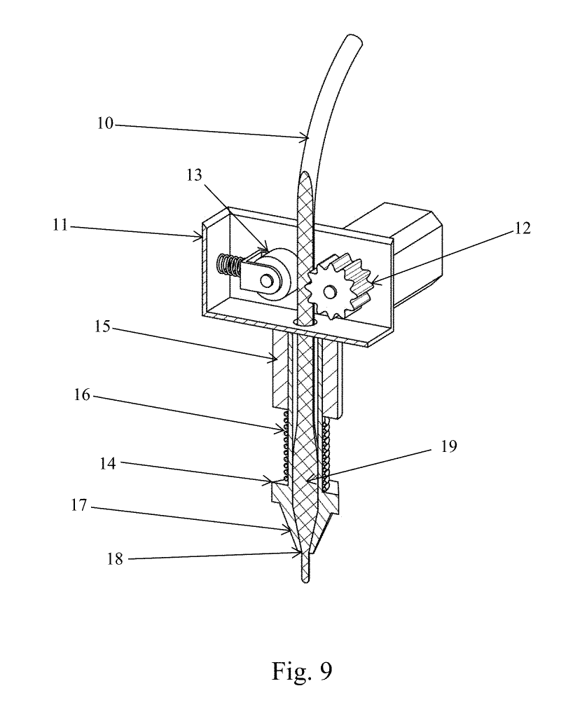

An embodiment of the printing device comprising separate extruders is useful, for example, in situations where a reinforcing layer (e.g., a reinforcing mesh) is printed on top of or in between printed concrete layers. In such an embodiment, when the reinforcing layer is to be printed, the concrete extruder ceases operation and only the composite material extruder feeds the reinforcing composite material. See FIG. 9 for an exemplary illustration of the design of the composite material extruder.

Referring to FIG. 9, which shows an embodiment of the composite material extruder, the composite material 10 enters the extruder via an opening in the housing 11, the housing 11 comprising within it a feeding gear 12 and a pressing roller (coupled to a spring which forces the composite material against the feeding gear via the pressing roller) 13, wherein the composite material 10 is fed between the feeding gear 12 and pressing roller 13. The pressing roller 13 forces the composite material 10 against the feeding gear 12 such that the feeding gear 12 is able to pull the thread of composite material 10. The housing 11 is connected to an outlet 14 through which the composite material 10 continues to run. The outlet 14 abuts the bottom of the housing 11 where the thread of composite material 10 exits the housing 10 via a second opening and enters the outlet 14. The outlet 14 is comprised of three portions—a thermoisolator 15, followed by a heater 16, followed by an extruder head 17. As the composite material 10 travels through the outlet 14, the thread is heated along the portion of the heater 16, causing the thread of composite material to become soft. Specifically, the thermoplastic binder of the composite material melts and the composite material becomes a more flexible fluid as a result. The thermoisolator 15 prevents the immediately following portion of thread from melting, as well as the portion of thread located in the housing 10. If these portions were to become heated, significant clogging would occur and the extruder mechanism would not function properly. The portions of the outlet 14 comprising the heater 16 and extruder head 17 comprise an interior opening with a larger diameter 19 than the diameter of the thread of composite material 10 in solid form to ensure against clogging within the outlet 14 and within the extruder head 17. Finally, the soft form of composite material 10 is extruded through the extruder head 17 located at the bottom end of the outlet 14. The soft form facilitates printing the composite material 10, which solidifies after it is extruded. The bottom tip 18 of the extruder head 17 where the soft form of composite material 10 is extruded comprises an opening with a diameter less than the diameter of the solid form of the composite material, such that a precise and thin form of soft composite material 10 is extruded in a pressurized and uniform manner. The extrusion process is controlled by software similar to the software for controlling a concrete extruder or a combined concrete-composite material extruder.

The control unit for the 3D printer and combination concrete mixer and pump 2101 can be housed in the base of the 3D printer (801B embodiment 1, 801A embodiment 2), and the extendable boom arm 201, in an ancillary unit such as the combination concrete mixer and pump 2101, or in another ancillary control unit (not shown). The control unit also aids in synchronizing and/or coordinating the extrusion of composite material with the extrusion of concrete, especially when the composite material and concrete are extruded through separate extruders.

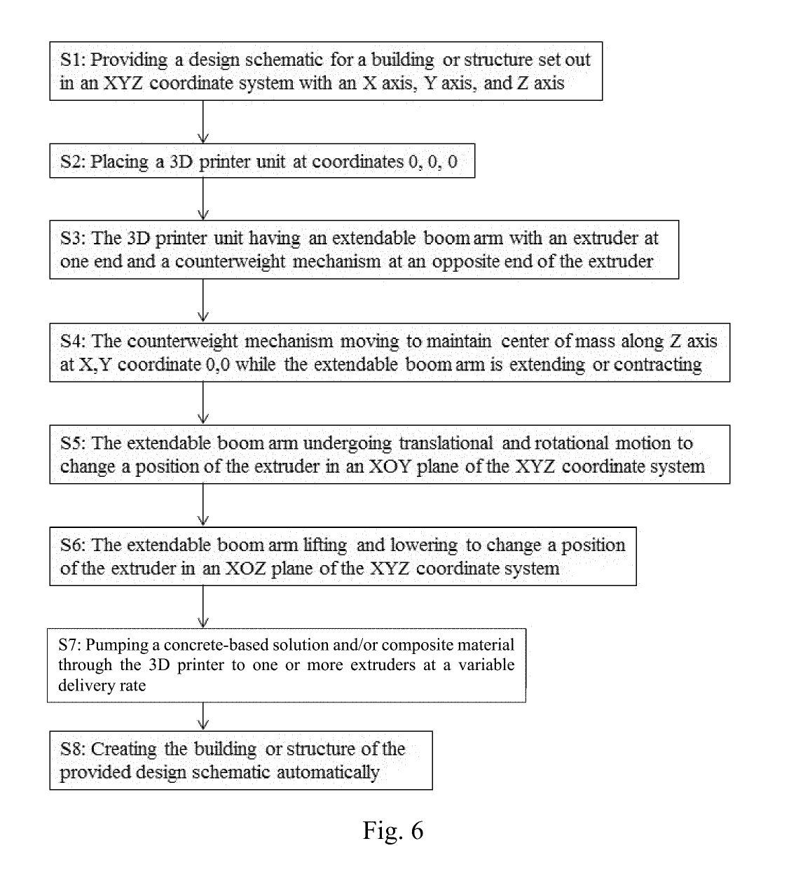

### Embodiment 3 (FIG. 6)

Operation of the 3D printer may be carried out according to the following method:

Step 1: providing a given design schematic for the building or structure set out in an XYZ coordinate system with an X axis, Y axis, and Z axis.

Step 2: placing a 3D printer unit at coordinates 0, 0, 0.

Step 3: the 3D printer unit having an extendable boom arm with an extruder at one end and a counterweight mechanism at an opposite end of the extruder.

Step 4: the counterweight mechanism moving to maintain center of mass along Z axis at X,Y coordinate 0,0 while the extendable boom arm is extending or contracting.

Step 5: the extendable boom arm undergoing translational and rotational motion to change a position of the extruder in an XOY plane of the XYZ coordinate system.

Step 6: the extendable boom arm lifting and lowering to change a position of the extruder in an XOZ plane of the XYZ coordinate system.

Step 7: pumping a concrete-based chemical solution and/or composite material through the 3D printer to one or more extruders at a variable delivery rate, said pumping being coordinated and/or synchronized by a control unit.

Step 8: creating the building or structure of the provided design schematic automatically.

### Embodiment 4

Second Method of Operation:

A second method of operation of the 3D printer involves:

Step 1: providing a given design schematic for the building or structure set out in an XYZ coordinate system with an X axis, Y axis, and Z axis.

Step 2: placing a 3D printer unit at coordinates 0, 0, 0.

Step 3: the 3D printer unit having an extendable boom arm with an extruder at one end and a counterweight mechanism at an opposite end of the extruder.

Step 4: the counterweight mechanism moving to maintain center of mass along Z axis at X,Y coordinate 0,0 while the extendable boom arm is extending or contracting.

Step 5: the extendable boom arm undergoing translational and rotational motion to change a position of the extruder in an XOY plane of the XYZ coordinate system.

Step 6: the extendable boom arm lifting and lowering to change a position of the extruder in an XOZ plane of the XYZ coordinate system.

Step 7: pumping a concrete-based chemical solution through the 3D printer to a first extruder for concrete printing and/or pumping a thread of composite material through the 3D printer to a second extruder for printing of composite material, each extruder being operable according to program software, each extrusion occurring at variable delivery rates based on a desired result.

Step 8: creating the building or structure of the provided design schematic automatically.

Rotation Mechanism (FIG. 5):

The rotation mechanism 801A has an outer housing 805 and an inner housing 807 with a bearing unit 809 between outer housing 805 and inner housing 807. The inner housing 807 and outer housing 805 both surround the concrete based chemical solution feed pipe (not shown). Mounted to the inner case are contactor rings 8011. The contactor rings 8011 are in electrically conductive contact with contactor antennae 8013 that extend from outer housing 805. The contactor rings 8011 and contactor antennae 8013 allow for power and operational commands for the 3D printer to be transmitted. The inner housing end 8015 is where power and control signals are provided to the 3D printer as a whole. The power and control signals pass through the inner case end which is electrically connected to the contactor rings 8011 and then to the contactor antennae 8013 which is electrically connected to outer housing end 8017.

Bearing unit 809 is in direct contact with the concrete based chemical solution and/or composite material feed pipe (not shown) and provides the bearings that give outer housing 805 and inner housing 807 the ability to rotate around the concrete based chemical solution and/or composite material feed pipe. The feed pipe connects to connection hose or pipe 2201.

The device allows for the transmission of fluid or material through a sealed pipe while rotating the outer housing 805 and the inner housing 807 in different directions with respect to a single axis and ensures the transfer of the electrical signal during operation from the base of the 3D printer to the top of the 3D printer through the rotation mechanism 801A through the contactor rings 8011 and contactor antennae 8013.

The pipe or pipes through which a liquid (mixture of concrete) moves is formed by two bodies—the outer housing 805 and inner housing 807, which rotate freely relative to each other. The ability to rotate freely relative to each other is provided by the bearing unit 809. The electrical signal is transmitted from one part to another by sliding contacts. On the inner housing 807 located a contactor ring 8011 which connect to contactor antennae 8013. Contactor antennae 8013 mounted in the outer housing 805. From contactor rings 8011 electrical signal is fed through the inner housing 807 at the inner housing end 8015. From contactor antennae 8013 signal is fed through the outer housing 805 to another outer housing end 8017. The contactor rings 8011 encircle inner housing 807.

Transfer of the liquid and signals is thereby available in rotation in one enclosure, and in different directions, and in a static position. Location of the rings and the contactor antennae may be both in the description above, and vice versa contactor ring 8011 arranged in the outer housing 805, and the contactor antennae 8013 located in the inner housing 807 in an alternative embodiment of the invention. The contactor rings 2011 are mounted to non-conductive inserts (not shown) and are not in direct electrical contact with the inner housing 807. The contactor antennae 8013 are mounted to non-conductive inserts (not shown) and are not in direct electrical contact with the outer housing 805.

Contactor antennae 8013 extend from outer housing 805 to the contactor rings 8011 on inner housing 807 acting as electrical contact brushes and allowing for electrical signals and power to be transferred from contactor rings 8011 to contactor antennae 8013 much like power is transferred in an electrical motor using brushes.

If a composite material is extruded with a concrete material, the spool of composite material is coupled to the concrete printing head. The composite material may be integrated with the concrete printer and be extruded through the same printing head for concrete printing, or alternatively, the composite material may be extruded via its own extruder alongside the concrete printing head. Both systems—the concrete system and the composite material system—are connected to the same control unit of the 3D printer and thus the systems are synchronized. The composite material is extruded, and the composite material printer travels, in a manner similar to the 3D concrete printer, i.e., using a polar coordinate system.

Therefore, in some aspects, the present invention discloses a composite material, comprising one or more roving materials, said roving material being impregnated with one or more thermosoftening plastic materials, wherein the composite material is fed into a 3D printing device, the composite material being a reinforcing material of a structure produced by the 3D printing device.

In some aspects, the present invention discloses a method for making a composite material, the method comprising heating in a bunker one or more thermoplastic materials to form a thermosoftened material, unwinding a roving material and feeding said unwound roving material into a heated die, feeding said thermosoftened material into the heated die, the thermosoftened material being driven into the die via a screw motor, impregnating the roving material with the thermosoftened material within the heated die, pulling the impregnated roving material through a shape-forming nozzle by a synchronized pulling machine, wherein the impregnated roving material solidifies once removed from the heated die to form a thread of composite material, the thread of composite material having a constant cross section, and winding the thread of composite material about a spool.

In some aspects, the present invention discloses a method for printing composite material, the method comprising providing a thread of composite material, said composite material comprising one or more roving materials, said roving material being impregnated with one or more thermosoftening plastic materials, and feeding said composite material thread into a 3D printer, said 3D printer extruding said composite material thread based on a polar coordinate 3D printing program.

In some aspects, the 3D printer extrudes the composite material thread alongside a concrete material, the composite material thread remaining in a solid form during printing.

In some aspects, the composite material thread and the concrete material are extruded via a same nozzle. In some aspects, the composite material thread and the concrete material are extruded via separate nozzles. In some aspects, a control unit coordinates an extrusion of concrete material and an extrusion of composite material thread.

In some aspects, the 3D printer extrudes the composite material thread in a thermosoftened form from a composite material extruder, said composite material extruder comprising a housing, an opening within said housing for receiving a composite material thread in a hardened form, a feeding gear within said housing, a pressing roller within said housing and positioned adjacent to said feeding gear such that said composite material thread in a hardened form is pulled further into said housing between said feeding gear and said pressing roller, an outlet through which said composite material thread continues to run, the outlet comprising a thermoisolator, a heater for heating the composite material thread into a thermosoftened form, and an extruder head for extruding the thermosoftened form of the composite material thread. In some aspects, the present invention discloses the composite material extruder alone.

In some aspects, a portion of the outlet comprising the heater has an opening with a diameter larger than a diameter of the composite material thread in a hardened form. Such a design is preferred because the composite material thread will expand upon heating, and thus the pressure inside the outlet does not increase with such a design. Increased pressure in this area leads to leakage, clogging, and breakage, which is undesirable.

In some aspects, a bottom end of the extruder head comprises an opening with a diameter less than a diameter of the composite material in a hardened form. This allows for a pressurized, continuous, and consistent extrusion of composite material in a uniform and thermosoftened state without the presence of any air gaps or bubbles.

In some aspects, the printer travels according to a polar coordinate system.

In some aspects, the composite material thread comprises ABS plastic. In some aspects, the composite material thread comprises PLA plastic. In some aspects, the composite material thread comprises nylon. In some aspects, the composite material thread comprises high density polyethylene (HDPE). In some aspects, the composite material thread comprises a combination of two or more thermoplastic materials.

In some aspects, the composite material thread comprises a combination of a glass roving and a second roving.

In some aspects, the composite material extruder is synchronized with a concrete material printer. In some aspects, the composite material extruder and the concrete material printer are connected to a same control unit.

The description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What is claimed is:

1. A composite material, comprising:
one or more roving materials,
said roving material being impregnated with one or more thermosoftening plastic materials,
wherein the composite material is fed into a 3D printing device, the composite material being a reinforcing material of a structure produced by the 3D printing device.

2. A method for making a composite material, the method comprising:
heating in a bunker one or more thermoplastic materials to form a thermosoftened material,
unwinding a roving material and feeding said unwound roving material into a heated die,
feeding said thermosoftened material into the heated die, the thermosoftened material being driven into the die via a screw motor,
impregnating the roving material with the thermosoftened material within the heated die,
pulling the impregnated roving material through a shape-forming nozzle by a synchronized pulling machine, wherein the impregnated roving material solidifies once removed from the heated die to form a thread of composite material, the thread of composite material having a constant cross section, and
winding the thread of composite material about a spool.

3. A method for printing composite material, the method comprising:
providing a thread of composite material, said composite material comprising:
one or more roving materials,
said roving material being impregnated with one or more thermosoftening plastic materials, and
feeding said composite material thread into a 3D printer, said 3D printer extruding said composite material thread based on a polar coordinate 3D printing program.

4. The method of claim 3, wherein the 3D printer extrudes the composite material thread alongside a concrete material, the composite material thread remaining in a solid form during printing.

5. The method of claim 4, wherein the composite material thread and the concrete material are extruded via a same nozzle.

6. The method of claim 4, wherein the composite material thread and the concrete material are extruded via separate nozzles.

7. The method of claim 6, wherein a control unit coordinates an extrusion of concrete material and an extrusion of composite material thread.

8. The method of claim 3, wherein the 3D printer extrudes the composite material thread in a thermosoftened form from a composite material extruder, said composite material extruder comprising:
a housing,
an opening within said housing for receiving a composite material thread in a hardened form,
a feeding gear within said housing,
a pressing roller within said housing and positioned adjacent to said feeding gear such that said composite material thread in a hardened form is pulled further into said housing between said feeding gear and said pressing roller,
an outlet through which said composite material thread continues to run, the outlet comprising:
a thermoisolator,
a heater for heating the composite material thread into a thermosoftened form, and
an extruder head for extruding the thermosoftened form of the composite material thread.

9. The method of claim 8, wherein a portion of the outlet comprising the heater has an opening with a diameter larger than a diameter of the composite material thread in a hardened form.

10. The method of claim 8, wherein a bottom end of the extruder head comprises an opening with a diameter less than a diameter of the composite material in a hardened form.

11. The method of claim 8, wherein the printer travels according to a polar coordinate system.

12. The method of claim 8, wherein the composite material thread comprises ABS plastic.

13. The method of claim 8, wherein the composite material thread comprises PLA plastic.

14. The method of claim 8, wherein the composite material thread comprises nylon.

15. The method of claim 8, wherein the composite material thread comprises high density polyethylene (HDPE).

16. The method of claim 8, wherein the composite material thread comprises a combination of two or more thermoplastic materials.

17. The method of claim 8, wherein the composite material thread comprises a combination of a glass roving and a second roving.

18. The method of claim 8, wherein the composite material extruder is synchronized with a concrete material printer.

19. The method of claim 18, wherein the composite material extruder and the concrete material printer are connected to a same control unit.
